(19) United States
(12) Patent Application Publication
(10) Pub. No.: US 2020/0354050 A1
(43) Pub. Date: Nov. 12, 2020

(54) CONVERTIPLANE

(71) Applicant: OBSCHESTVO S OGRANICHENNOI OTVETSTVENNOSTYU "TEKHNOVETER" [RU/RU], Moscow (RU)

(72) Inventor: Ellina Vladimirovna ZIMENSKAYA, Kazan (RU)

(73) Assignee: OBSCHESTVO S OGRANICHENNOI OTVETSTVENNOSTYU "TEKHNOVETER" [RU/RU], Moscow (RU)

(21) Appl. No.: 16/765,950

(22) PCT Filed: Nov. 21, 2018
(86) PCT No.: PCT/RU2018/050149

§ 371 Date: May 21, 2020

(30) Foreign Application Priority Data
Nov. 23, 2017 (RU) 2017140934

(51) Int. Cl. B64C 29/00; B64C 11/46

(52) U.S. Cl. CPC B64C 29/0033; B64C 11/46

(57) ABSTRACT

The invention relates to the field of aviation, and more particularly to designs for vertical take-off and landing aircraft. A convertiplane comprising a fuselage, a pair of wings: fore and aft, propulsion systems comprising engines and propellers, a keel, a landing gear, and pylons designed so as to be rotatable. Two lift propulsion systems are arranged on the pylons with one degree of freedom with respect to the yaw angle along the sides of the fuselage so as to be fixable in position and retractable during horizontal flight forward or back in fuselage niches. A basic propulsion system is mounted on a pylon with two degrees of freedom with respect to the angle of bank and pitch so as to be fixable in position, and is arranged either in the nose section of the fuselage or in the keel, on the leading edge or the trailing edge thereof. This provides improved reliability and safety, increased flight range and reduced cost of the convertiplane.

### FIELD OF THE INVENTION

The invention relates to the field of aviation, in particular to the design of aircraft vertical take-off and landing. The invention can be used in all areas of traditional applications of airplanes, helicopters, convertiplanes, unmanned aerial vehicles.

### BACKGROUND

Known convertiplane (Patent RU No. 2456209 C1, IPC B64C37/00-20.07.2012, Bull. No. 20), including the fuselage, wing, engines, plumage, landing gear. On the wing are pylons made with the possibility of rotation. The pylons are equipped with two front engines. The rear engine is mounted on the pylon. Chassis racks combined with wing pylons and keel, respectively. The aircraft is balanced in all flight modes.

The disadvantages of this technical solution are low carrying capacity, low range and flight duration due to the low efficiency of propulsion systems, because they are simultaneously lifting and marching, as well as excessive propulsion system power in horizontal flight, as a result of their forced operation at low efficiency.

The closest to the claimed technical solution is a convertiplane (Patent RU No. 2635431 C1, IPC B64C37/00-11/13/2017, Bull. No. 32), containing the fuselage, front and rear wings, propulsion systems containing engines and propellers, landing gear, pylons made with the possibility of rotation, two lifting propulsion systems located on pylons with two degrees of freedom at the corners of the pitch and the ridge on the sides of the fuselage, with the possibility of fixing the position and retracted when flying horizontally forward or backward into the niches of the fuselage. The marching propulsion system is located on a pylon with two degrees of freedom in the corners of the roll and pitch with the possibility of fixing the position in the rear of the fuselage. This patent is taken as a prototype.

The disadvantages of this convertiplane are the vulnerability of the marching propulsion system installed in the rear of the fuselage during take-off and landing from irregularities of the underlying surface, also the high technical complexity, high weight and large occupied volume in the fuselage of pylons of lifting propulsion systems should be attributed to the disadvantages of this convertiplane.

### SUMMARY OF THE INVENTION

The objective of the invention is the creation of a convertiplane designed for transportation, a simple design, balanced in all flight modes, capable of performing horizontal flight, vertical take-off and landing and hovering in one place. The usefulness of a convertiplane lies in the possibility of take-off and landing from a smallest site and in reducing transportation time due to the ability to deliver a target load to a consumer as close as possible.

The technical result is an increase in the reliability of the design, large carrying capacity, range, flight duration and reducing the cost of convertiplane.

The specified technical result is achieved by a convertiplane comprising a fuselage, a pair of wings: fore and aft, a keel, two lifting propulsion systems, comprising engines and propellers located on pylons along sides of the fuselage configured to be fixed in a position, said engines and propellers are made retractable during horizontal flight into a fuselage cavity; and a marching propulsion system comprising an engine and a propeller; wherein the pylons of the lifting propulsion systems are made with one degree of freedom with respect to a yaw angle, and the marching propulsion system is made with two degrees of freedom with respect to angles of bank and pitch, configured to be fixed in a position, and is located in a nose section of the fuselage, or on a front or rear edge of the keel, or on a leading edge or on a trailing edge of the keel.

The advantage provided by the given set of features is a decrease in technical complexity, a decrease in prime cost and an increase in reliability, as well as a reduction in empty weight and an increase in flight range and duration, this is ensured by the transition from two degrees of freedom to one degree of freedom for pylons of lifting propulsion systems, it is also provided placing the pylon of the marching propulsion system on the keel, in addition, the number of keels is reduced from two to one.

### BRIEF DESCRIPTION OF THE DRAWINGS

The invention is illustrated by drawings, which depict:

FIG. 1—shows a general view of a convertiplane, takeoff and landing flight mode (marching propulsion system installed on the rear edge of the keel).

FIG. 2—presents a view of the convertiplane during acceleration (marching propulsion system is installed on the rear edge of the keel).

FIG. 3—presents a view of a convertiplane in horizontal flight. Lifting propulsion systems are retracted to the fuselage niches.

FIG. 4—presents a view of the convertiplane during acceleration (the marching propulsion system is installed on the front edge of the keel),

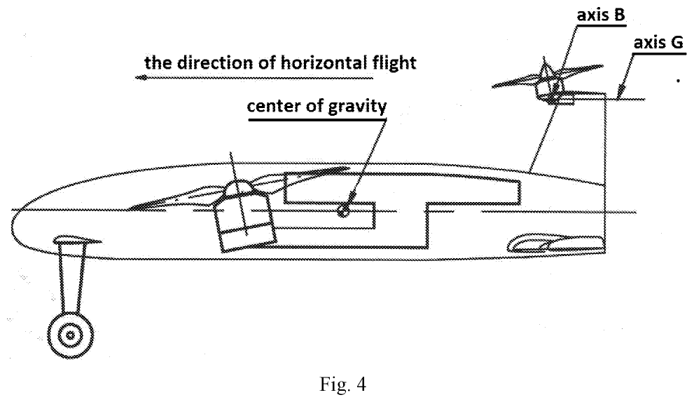

where 1 is the fuselage;

2—front wing;

3—rear wing;

4—keel;

5—lifting propulsion systems;

6—marching propulsion system;

7, 8—differential aerodynamic rudders;

9—pylon of the lifting propulsion system;

10—pylon of the marching propulsion system;

11—fuselage niches for retraction of lifting propulsion systems.

### DETAILED DESCRIPTION OF THE INVENTION

The present invention contains a fuselage 1, which serves to accommodate a target load, elements of the control system and other systems; the front wing 2 and the rear wing 3, keel 4, lifting propulsion systems 5, including an engine and a propeller, are placed on rotary pylons 9 on the sides of the fuselage to create lift in takeoff/landing modes; marching propulsion system 6, comprising an engine and a propeller located on the pylon 10 on the front or rear edge of the keel, which serves to create traction in all flight modes; differential aerodynamic rudders 7 and 8 for controlling the convertiplane in horizontal flight; fuselage niches 11 for cleaning lifting propulsion systems.

This invention has several features:

1. On takeoff and landing flight mode, the convertiplane has a fixed pitch angle in the range from 5 to 15 degrees. Acceleration and braking is carried out by tilting the entire convertiplane forward-backward, that is, the speed of the convertiplane is controlled by the pitch angle.

2. If the main propulsion system is not located in the nose of the fuselage, it is mounted both on the front edge of the keel, in this case it is equipped with a pulling screw, and on the rear edge of the keel, in which case it is equipped with a pushing screw.

3. Pylons of lifting propulsion systems have one degree of freedom.

The device works as follows: there are two different flight modes of a convertiplane: takeoff and landing mode and horizontal flight.

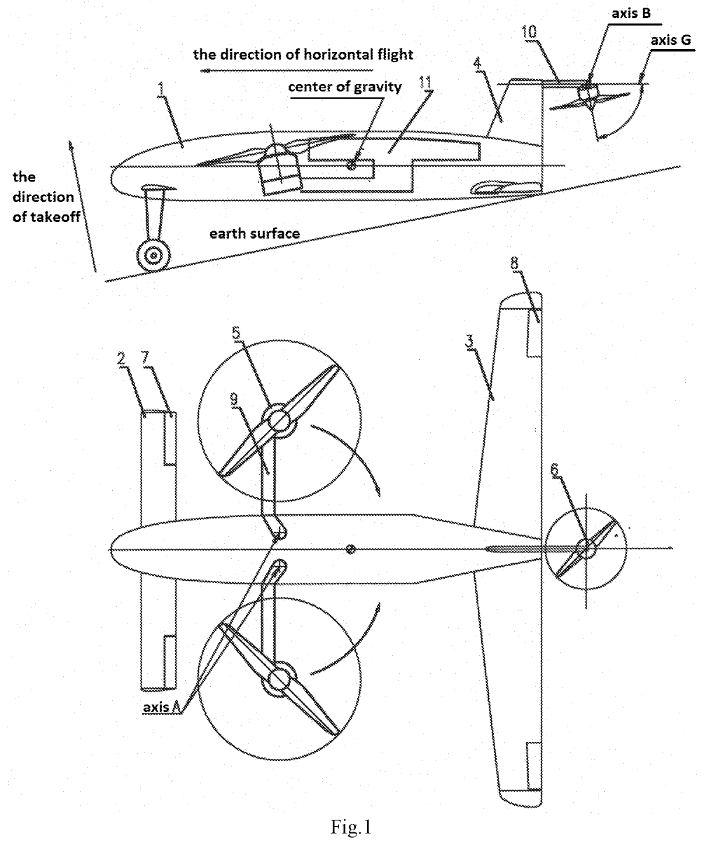

In the take-off and landing mode (FIG. 1), all three propulsion systems operate and are installed in the operating position “up”. The control is carried out by the pitch angle of the convertiplane, the rotation of the lifting propulsion systems relative to the axes A (along the yaw angle) and the rotation of the marching propulsion system relative to the axes B and G (along the pitch and roll (bank) angles). Deviation is carried out using servos. In addition, the control of the convertiplane is carried out by changing the speed of the propulsion systems.

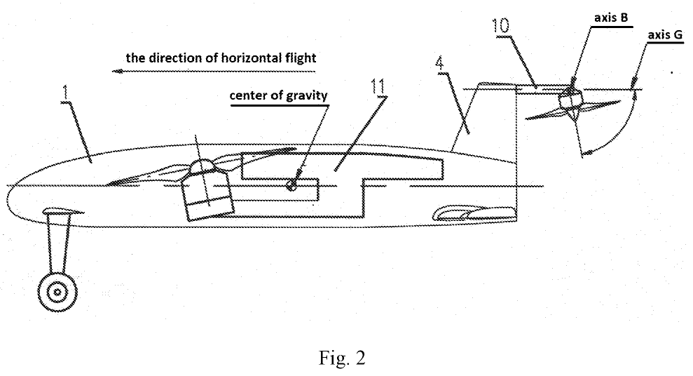

After take-off, the convertiplane leans forward, and the marching propulsion system is rotated by a certain angle to create horizontal thrust (FIG. 2). This ensures acceleration of the convertiplane to the minimum horizontal flight speed. After that, the lifting propulsion systems are stopped and retracted into the fuselage niches by turning the engine nacelles around axis A (along the yaw angle). When braking, on the contrary, with working lifting propulsion systems, the marching propulsion system is in position to create a negative traction, and the convertiplane is set to a positive angle of attack.

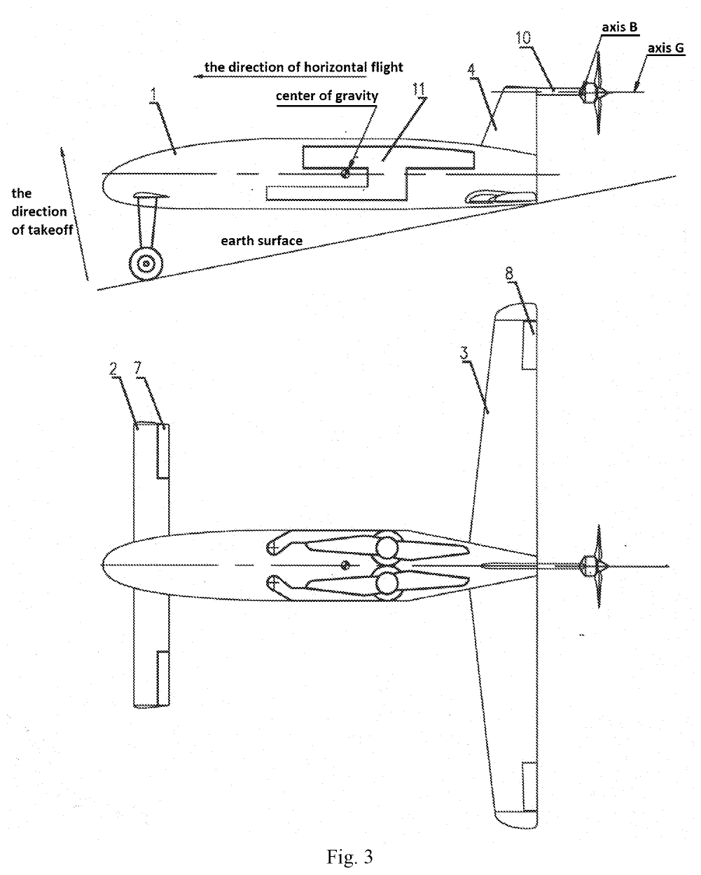

In a horizontal flight (FIG. 3), the lifting force is created by the wings, the thrust is created by the marching engine, and the control is carried out by differential rudders (which can be installed on both the front and/or rear wings). In the event of failure (or in the initial absence) of the differential rudders, the marching propulsion system is controlled by turning relative to the B and D axes. If the marching propulsion system fails, it is possible to land “glider” under the control of differential rudders, or (if any) by parachute.

Compared with the prototype, the claimed technical solution has a number of technical and economic advantages, namely:

1. Pylons of lifting propulsion systems have only one degree of freedom, which reduces the weight of an empty convertiplane by 10% due to the lack of a rotation mechanism along the pitch angle and frees up the internal volumes of the fuselage by 5%. In addition, the technical complexity of the structure decreases and its reliability increases.

2. The marching propulsion system, if it is located in the tail of the convertiplane, is located on the keel, which reduces the requirements for the quality of coverage of the runway, increases the reliability of the marching propulsion system and allows you not to install the chassis on the convertiplane, or reduces the required height of the landing gear. In the absence of a chassis, empty weight is reduced by 10%.

1. A convertiplane comprising a fuselage, a pair of wings: fore and aft, a keel, two lifting propulsion systems, comprising engines and propellers located on pylons along sides of the fuselage configured to be fixed in a position, said engines and propellers are made retractable during horizontal flight into a fuselage cavity; and
a marching propulsion system comprising an engine and a propeller; wherein the pylons of the lifting propulsion systems are made with one degree of freedom with respect to a yaw angle, and the marching propulsion system is made with two degrees of freedom with respect to angles of bank and pitch, configured to be fixed in a position, and is located in a nose section of the fuselage, or on a front or rear edge of the keel, or on a leading edge or on a trailing edge of the keel.

2. The convertiplane according to claim 1, wherein the engines of the lifting propulsion systems are made as electric motors, or as reciprocating internal combustion engines, or as gas turbine engines.

3. The convertiplane according to claim 1, wherein the engines of the lifting propulsion systems are made with propellers, while the propellers are made foldable.

4. The convertiplane according to claim 1, wherein the lifting propulsion systems containing engines located on pylons along the sides of the fuselage configured to be fixed in a position are retracted during horizontal flight forward or backward into the fuselage cavity.

5. The convertiplane according to claim 1, wherein the marching propulsion engine is made in as an electric motor, or as a reciprocating internal combustion engine, or as a gas turbine engine.

6. The convertiplane according to claim 1, wherein it is made with a landing gear.

7. The convertiplane according to claim 1, wherein it is made with a parachute.
